(19) United States
(12) Patent Application Publication
(10) Pub. No.: US 2017/0194885 A1
(43) Pub. Date: Jul. 6, 2017

(54) MECHATRONIC ASSEMBLY FOR DRIVING AN EXTERNAL MEMBER USING A BRUSHLESS MOTOR AND A SIMPLE ASSEMBLY OF ELECTRONIC COMPONENTS

(71) Applicant: MMT SA, Zug (CH)

(72) Inventors: Eric RONDOT, Berthelange (FR); Gaël ANDRIEUX, Evilard (CH)

(73) Assignee: MMT SA, Zug (CH)

(21) Appl. No.: 15/313,348

(22) PCT Filed: Jun. 8, 2015
(86) PCT No.: PCT/EP2015/062657

§ 371 Date: Nov. 22, 2016

(30) Foreign Application Priority Data
Jun. 12, 2014 (FR) 1455348

(51) Int. Cl. H02P 6/17; F02D 13/02; H02P 6/08

(52) U.S. Cl. CPC H02P 6/17; H02P 6/085; F02D 13/02

(57) ABSTRACT

A mechatronic assembly for driving a member, includes a control unit and an actuator, the control unit having a servo control algorithm and a power bridge, the algorithm controlling the power bridge, the power bridge outputting a bifilar electric signal consisting of a power signal and a direction signal, the actuator including a polyphase brushless electric motor having n-phases, binary sensors for detecting the position of the rotor of the motor, power switches being capable of powering the n-phases of the motor using the bifilar electric signal, and a state of the power switches being controlled directly by a signal from the detection sensors.

### CROSS-REFERENCE TO RELATED APPLICATIONS

This application is a National Phase Entry of International Patent Application No. PCT/EP2015/062657, filed on Jun. 8, 2015, which claims priority to French Patent Application Serial No. 1455348, filed on Jun. 12, 2014, both of which are incorporated by reference herein.

### TECHNICAL FIELD

The present invention relates to the field of polyphase brushless DC electric (brushless or BLDC) motors. More particularly, it relates to a method for controlling such motors, not using microprocessors and requiring, for the motor, only two power supply wires.

### BACKGROUND AND SUMMARY

The need for mechatronic driving systems is increasingly urgent in many business sectors, also with increasingly rough environments. The automotive sector is not spared and the needs for OEMS to reduce emissions has led them to propose a multitude of combustion engine-related aggregates. Furthermore, the downsizing of motorizations and the profusion of peripheral functions further reduce the available spaces. De facto, the environments wherein the peripheral functions have to be implemented entail very harsh thermal and mechanical restrictions (temperature, vibrations, space available).

It is therefore essential to provide more and more resistant systems as regards such constraints. The brushless DC motor (BLDC) technology is adapted to such constraints, but is often hampered by a need for control electronics. Electronics quickly becomes a dead stop for ensuring useful time of the system at a high-temperature. Optimized and innovative solutions thus have to be developed.

In addition, the automotive sector is increasingly competitive and many mechatronic functions have come into the technological fold of DC motors with brushes. As a matter of fact, for reasons of systems cost, DC motors with brushes (BDC) are often preferred to brushless DC motors (BLDC), specifically and primarily because of an easy control but also because of the reduced electronic costs resulting from the absence of microprocessors. This is reinforced by the fact that many engine electronic control units (ECU) are equipped with (so-called “H-engine”) power bridges dedicated to the bi-directional control of single-phase actuators (DC or polarized or not-polarized solenoid engine).

However engineers might regret not being able, for purely economic reasons, to implement a technology offering unsurpassed advantages as compared to a DC motor: the BLDC motor which ensures strength, low wear, electromagnetic compatibility, compactness. Similarly, using an existing ECU makes it possible to accelerate the marketing of a product while avoiding the debugging and the validation of new driver and control software.

Many features, whether in the automotive sector or any other sector, require systems enabling a driving into rotation, whether mechanical or electrical. Electric actuators only will be discussed within the scope of this invention. In the present invention, “actuator” means the assembly consisting of an electric motor, any means for detecting the position of the motor rotor, any means of movement transformation, switching electronics and the connector.

Two major families of actuators can be identified:

The so-called “dumb” actuators or not smart actuators. Such an actuator 2 is shown in FIG. 1, the actuator 2 comprises a DC motor with brushes 20 and a driving output 12, and optionally a speed-transforming gear 9. The smart part in charge of speed servo-control, is positioned in remote electronics 1, so-called ECU (Electronic Control Unit) by the persons skilled in the art.

The so-called ‘smart’ or intelligent actuators. The actuator comprises a micro-controller in charge of speed servo-control. Usually this type of actuator is controlled by either a PWM signal or a LIN or CAN communication bus recognized as standards in the automotive sector.

As regards automotive applications close to heat engines, such as, for instance, main or auxiliary water pumps used for engine cooling, the “dumb” solution is preferred by far to the “smart” solution for reasons of electronic components, specifically the micro-controller, compatibility at a high temperature. In a “dumb” solution as schematically shown in FIG. 1, an ECU 1 determines, from information obtained through the process, the actuator 2 speed, and then calculates a power (torque and speed) and direction signal 6 applied to a DC motor with brushes 20. The mechanical output 12 is coupled to an external member (not shown) to be moved such as a pump body for example. The action on the motor 20 is transmitted to the mechanical output 12 of the actuator 2, generally directly, i.e. with no transformation, or optionally via a speed transformation mechanical stage 9. This closed loop thus makes it possible to servo-control the speed of the mechanical output 12 of the actuator 2. The connections 3 between the ECU 1 and the actuator 2 are few: 2 wires for the DC motor with brushes 20, the differential signal between the two wires of which can be a positive or a negative signal. The DC motor 20 is responsive to the torque and direction signals 6 provided by the ECU 1 through a so-called H power bridge (FIG. 23) consisting of four transistors 15a, 15b, 15c, 15d.

U.S. Pat. No. 5,773,941 describes an invention used to uni-directionally control a three-phase brushless DC motor using two wires, i.e. a reference wire (ground or 0V) and a power signal wire. An external power supply delivers the power signal which may be continuous or hashed. Switching electronics is self-powered by a rechargeable power supply taking its energy from the power signal.

Whether in industrial or automotive applications, the brushless DC motor is widespread and preferred today for the advantages it offers as compared to the DC motor as described in U.S. Pat. No. 4,365,187 (column 1, line 9). This type of motor is preferred in the single-phase brushless DC motor structure with 1 coil or 2 half-coils. Simple electronics which can be built close to the motor, or even in the engine housing, manages the self-switching of said engine from the signal provided by one or two Hall probe(s).

The increasing electrification of the functions provided under the hood of a car results in that the electric actuators are subject to various increasingly harsh constraints specifically as regards resistance to ambient temperatures above 125° C. Existing so-called “smart” systems wherein a micro-controller and/or complex electronics required for controlling a motor and servo-controlling the speed of one actuator, are limited as regards the ambient temperature. The type of economically “viable” component does not make it possible to go beyond 125° C. and often requires expensive cooling means.

As for the existing so-called “dumb” systems, they are compatible with the desired ambient temperature since the actuator includes no complex and sensitive electronic component. Only such an actuator uses a DC motor with brushes which, from an industrial point of view, will be less efficient and compact than a brushless DC motor which also has the significant advantage of a much longer service life than the traditional DC motor with brushes. It is recognized by the persons skilled in the art that DC motors with brushes are sources of electromagnetic interference, which is a sensitive issue in an environment increasingly occupied by electronic systems and other computers.

One of the conventional structures of polyphase brushless DC motors is connected to three either star- or delta-shaped phases thus providing three connection points for the motor supply. The self-switching of a brushless DC motor for a positioning application requires the use of three sensors to determine the position of the motor rotor. Designing a “dumb” actuator with a brushless DC motor, instead of the DC motor with brushes, requires the use of a suitable ECU designed for three-phase motor control, i.e. a three-phase bridge with six transistors and five points of connection with the rotor probes. The speed control systems which control the actuator in all 4 quadrants require bidirectional control of the motor rotation, which cannot be achieved by the invention described in U.S. Pat. No. 5,773,941, the input of which (marked 22 in this text) accepts one polarity only.

The other mainly single-phase applications of brushless DC motors as described in U.S. Pat. No. 4,365,187 are mainly used for fans or pumps requiring only one direction of rotation and having no need for braking. As described in column 5 line 3 of the above-mentioned patent, the engine structure, as regards its geometry or the positioning of sensors, must be so designed as to ensure proper engine starting in the preferred direction of rotation. The single-phase brushless DC motor and control electronics thereof are thus not suitable for driving applications in the 4-quadrant mode, the subject of the present invention.

The present invention relates to a control system powered by an energy source and a driving-operating actuator. The control system will control the actuator using a speed control algorithm. The invention aims at providing an actuator driven by a brushless DC motor, while keeping the existing elements identical to the system based on a DC motor with brushes. The actuator is connected to the control system through a 2-point connector gathering the signals combining the direction and the torque to be produced by the BLDC motor.

A basic electronic circuit resistant to high temperatures (>125° C.) manages the self-switching of the N phases of the motor using N probes giving the position of the motor rotor. The objective of the solution described below is to provide a technological compromise making it possible to remedy the issues mentioned above and to offer an economical solution requiring no microprocessor, enabling the use of a brushless DC motor instead a DC motor with brushes, while keeping the possibility of using a reversible polyphase motor and controlling it in both directions of rotation. The invention is thus applicable to any N-phase polyphase motor.

The present invention provides an economical solution to the substitution of a DC motor with brush with a brushless DC motor, complying with the following criteria:

1—keeps an existing remote control unit (ECU) without any modification in hardware or software.

2—immediate interchangeability with already existing products.

3—Increases the actuator service life.

4—Allows bidirectional control of the motor.

5—Very few electronic components (simple and strong) aboard the actuator.

6—The components used are compatible with and resistant to ambient temperatures >125° C.

7—Brushless DC motor and limited number of components enable highly compact integration.

8—Gain on the weight of the actuator.

9—Reduced electromagnetic interference.

The invention more particularly relates to a mechatronic assembly for driving a member comprising a control unit and an actuator, with the control unit comprising a servo-control algorithm and a power bridge, with said algorithm controlling said power bridge, with the power bridge outputting a bifilar electric signal, with the actuator comprising a polyphase brushless electric motor having N phases, binary probes for detecting the position of the rotor of said motor, power switches suitable for supplying the N phases of the motor from the bifilar electric signal, characterised in that the state of the power switches is directly controlled by a signal emitted by the detection probes. “Directly controlled” means that the signal controlling the state of the power switches originates:

1—from the output of a detection probe,

2—or from the logic combination of several sensor probes,

3—or from the combination of one or more detection probe(s) and a direction signal (direction of rotation of the motor, as written below). No other processing than very simple logic operations is applied between the signal from the detection probes and the power switches status command. These simple operations are achievable with logic gates or discrete components such as transistors, diodes, resistors.

In a preferred embodiment, the direction of rotation of the motor is imparted by an elementary combinational logic built from the polarity of the bifilar electric signal and the signal from the detection probes. In a preferred embodiment, the binary sensors for detecting the position of the rotor are supplied by the bifilar electric signal. In a specific embodiment, the bifilar electric signal is a continuous signal, the amplitude of which is controlled by the servo-control algorithm. In another embodiment, the bifilar electric signal is a hashed signal, the duty cycle of which is controlled by the servo-control algorithm. In a preferred embodiment, the bifilar signal is rectified by a diode bridge so as to feed the N phases of the motor with a positive current.

It should be noted that the invention is more particularly intended to the field of automobiles, even though this utilization is not exclusive. As a matter of fact, the fluid-driving pumps (oil, air, fuel) applications are concerned by the invention, as well as the driving systems, such as those disclosed, for instance in patent WO2003095803 which enable the camshaft phase shift or the valve lift as disclosed in U.S. Pat. No. 7,225,773, for instance.

### BRIEF DESCRIPTION OF THE DRAWINGS

Other characteristics and advantages of the invention are mentioned in details in the following description which is indicative and not restrictive while referring to the appended drawings, in which:

FIG. 1 shows a mechatronic assembly of the prior art;

FIG. 2 shows a mechatronic assembly according to the present invention;

FIG. 3 shows one example of the various multiphase coils of the motors which the invention relates to;

FIG. 4 shows in details the basic electronic circuit within a bidirectionally controlled actuator;

FIG. 5 shows in details the basic electronic circuit within a unidirectionally controlled actuator;

FIG. 6 shows the supply of the switching logic according to a preferred embodiment;

FIG. 7 shows the torques common according to a first so-called “120° unipolar” operation mode;

FIG. 8 shows the torques common according to a second so-called “180° unipolar” operation mode;

FIG. 9 shows the torques common according to a third so-called “mid-point two-phase bipolar” operation mode;

FIG. 10 shows the setting of the probes in the scope of the two embodiments shown in FIGS. 7 and 8;

FIG. 11 shows the electronic circuit of the switching logic according to the first “120° unipolar” operation mode and its truth table;

FIG. 12 shows the electronic circuit of the switching logic according to the second “180° unipolar” operation mode and its truth table;

FIG. 13 shows the electronic circuit of the commutation logic according to the third “mid-point two-phase bipolar” operation mode and its truth table;

FIG. 14 shows a portion of the electronic circuit of the switching logic (if applicable to the diagram illustrated in FIG. 11, FIG. 12 and FIG. 13) according to a particular embodiment enabling the bidirectional control of the motor and its truth table;

FIG. 15 shows a portion of the electronic circuit of the switching logic (if applicable to the diagram illustrated in FIG. 11, FIG. 12 and FIG. 13) according to a particular embodiment enabling the bidirectional control of the motor and its truth table, and as an alternative to the solution proposed in FIG. 14;

FIG. 16 shows a portion of the electronic circuit of the switching logic according to a particular embodiment enabling the bidirectional and bipolar control of the motor, and its truth table;

FIG. 17 shows a portion of the electronic circuit of the switching logic according to a particular embodiment enabling the (magnetic) bidirectional and bipolar control of the motor, and its truth table;

FIG. 18 shows a circuit for extracting the management information contained in the control signal;

FIG. 19 shows a circuit for extracting the management information contained in the control signal, and as an alternative to the solution provided in FIG. 18;

FIG. 20 discloses the signals of FIGS. 18 and 19;

FIG. 21 shows a circuit for extracting the management information contained in the control signal, and as an alternative to the solution provided in FIG. 18;

FIG. 22 shows the signals of FIG. 21;

FIG. 23 shows the typical configuration of the power bridge of a control unit.

### DETAILED DESCRIPTION OF EXEMPLARY EMBODIMENTS

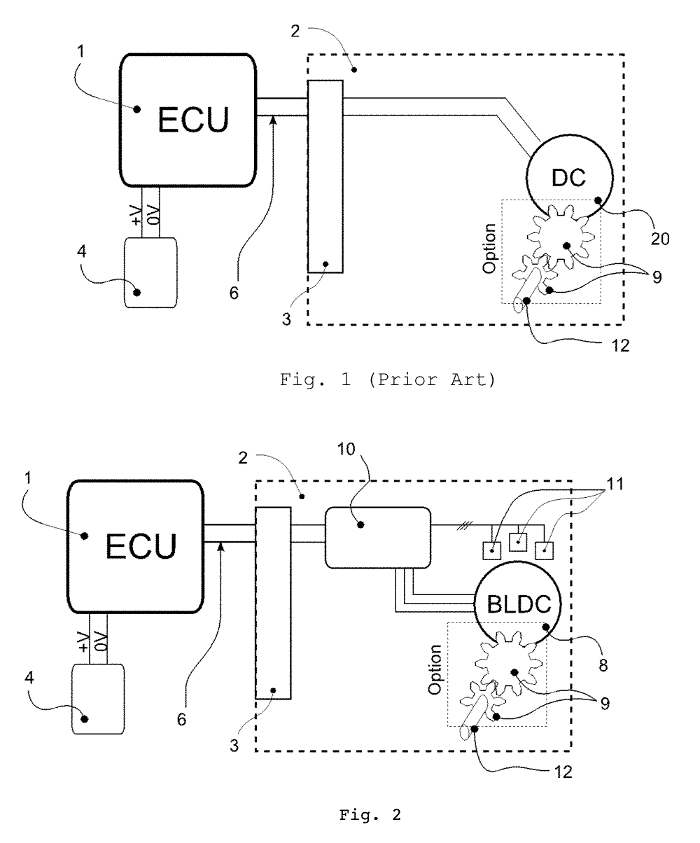

FIG. 1 shows, according to the prior art, a mechatronic driving assembly commonly used in the existing systems, consisting of a power source 4 supplying a control unit 1 controlling an actuator 2 consisting of a DC motor with a brush 20 possibly associated with a speed transforming mechanical assembly 9. A control system 1 acts on the combined torque and direction signals 6 grouped in a link connector 3 so as to control the speed of the actuator 2. The mechanical output 12 is coupled to an outer member to be moved like a pump body for example and in a car application.

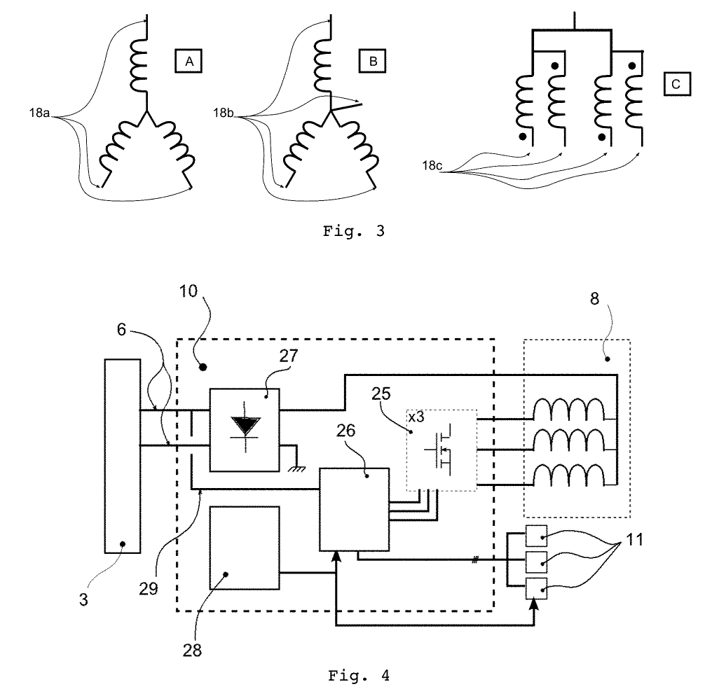

FIG. 2 shows a mechatronic assembly according to the invention comprises a power source 4 supplying a control unit 1 controlling an actuator 2 comprising a brushless DC motor 8 optionally associated with a speed transforming mechanical assembly 9. A control unit 1 acts on the combined torque and direction signals 6 grouped in a link connector 3. The position of the motor rotor 8 is read using N sensors 11 which self-switch the N phases of the motor 8, via a basic electronic circuit 10.

It should be noted that the signal from the N probes 11, in the illustrations shown here, is never sent back to the control system 1, but it may be considered to send back such signal from the N probes 11 to the control system 1 in order to decide, if need be, on a correction or to inform the system of the effective operation status of the motor. Similarly, the probes 11 for detecting the position of the rotor may be positioned close to the rotor in order to detect the variations in the magnetic field emitted by the rotor or remote as an encoder placed upstream or downstream of the rotor, with a mechanical connection shaft securing the rotor and the encoder.

A driving system (FIG. 2), consists of a so-called ECU remote electronic control unit 1, and an actuator 2 integrating a basic electronic circuit 10 utilizing the signals from the probes 11 providing information on the position of the rotor of a brushless DC motor 8 for self-switching thereof. The present invention applies to any type of polyphase brushless DC motor as shown by some examples of three-phase (A and B) and two-phase (C) topologies shown in FIG. 3. To simplify reading, the following descriptions will be based on a subset of N, between 2 and 3 only, with N being the number of phases of the brushless DC motor. The ECU 1 powered by the car battery 4, executes a speed servo-control algorithm and generates the torque and direction signals 6 to be sent to the motor which will act onto the mechanical output 12 of the actuator 2 through a speed transforming mechanism 9. The electronic self-switching circuit 10 is so designed that the actuator 2, whether powered by a brushless DC motor (FIG. 2) or by a DC motor with brush (FIG. 1), provides compatibility as regards both functions and connections 3.

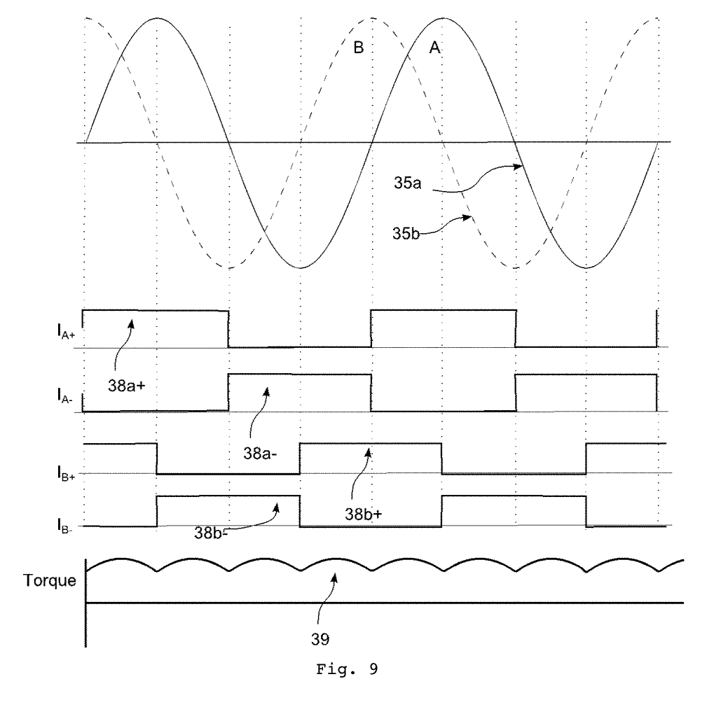

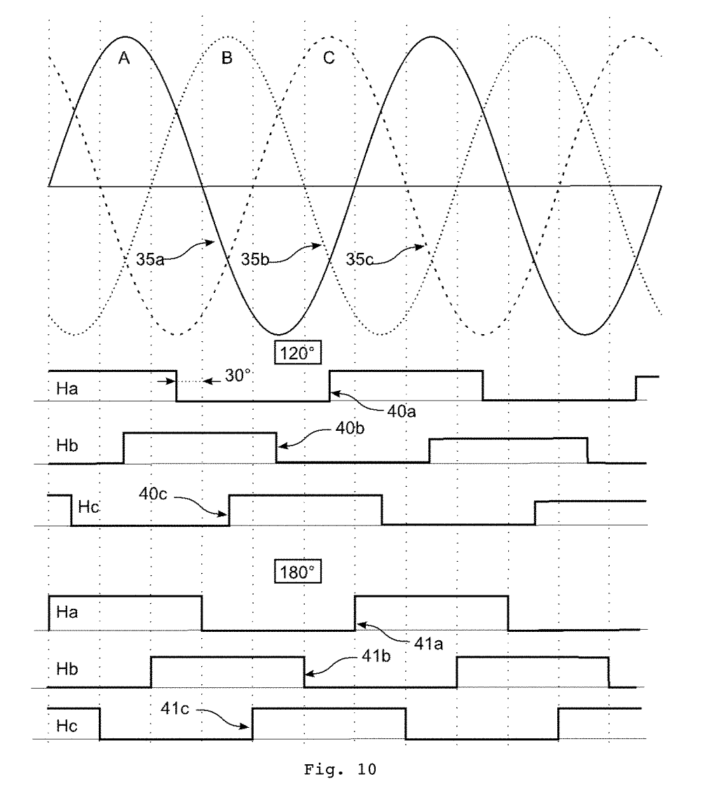

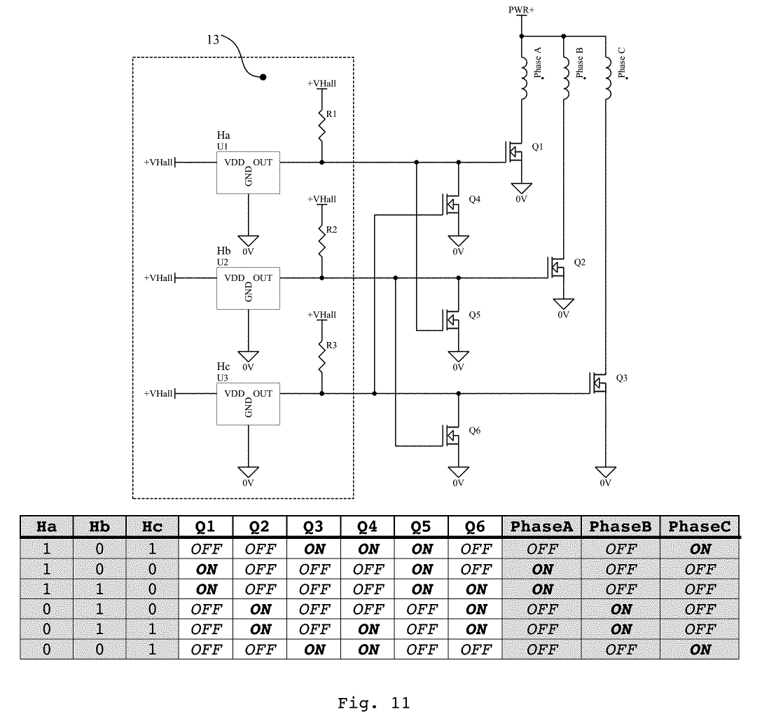

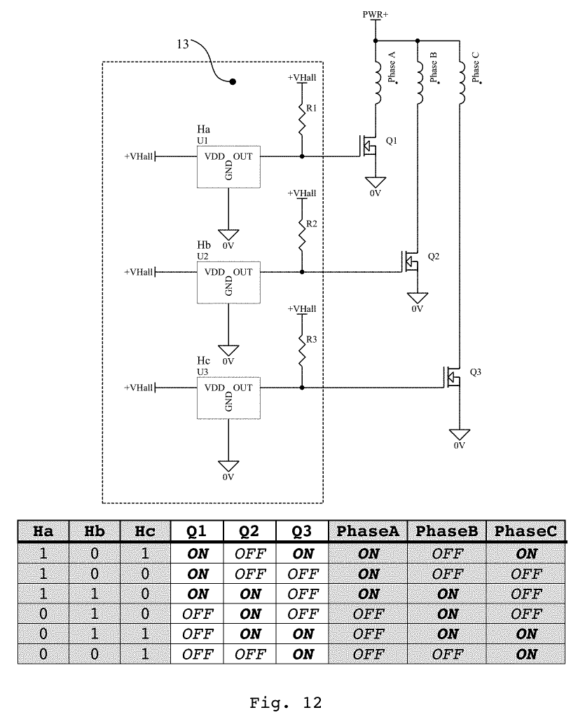

As a cost-saving measure, the brushless DC motor 8 is controlled in unipolar mode requiring only three transistors. Which also simplifies the self-switching circuit. A system requiring small torque variations will preferably work in the 180° mode (FIG. 9) with six motor steps per electric period as compared to three steps in the 120° mode (FIG. 8). The number of steps per electric period for each operating mode can be derived from the shape of the power signal (39 in FIGS. 8 and 37 in FIG. 7). The minimum electronic diagram for self-switching the brushless DC motor is shown in FIG. 11 and FIG. 12 for the 120° and 180° modes respectively.

For each of these modes, the shape of the currents in the motor phases is shown in FIG. 7 and FIG. 8 for the 120° and 180° respective modes. The probes switching time is different depending on the operating mode (120° or 180°). As shown in FIG. 10, setting is advanced by 30° in the case of the 120° mode to make it possible to get a current in phase with the back e.m.f., (back electromotive force) 35a, 35b, 35c which guarantees a maximum average torque, through the simplified electronics described in FIG. 11.

FIG. 7 shows the shape of the currents 36a, 36b, 36c for each phase of the motor 8 and the respective phase thereof relative to the back e.m.f. 35a, 35b, 35c of said motor 8 phases. This control mode is called 120° unipolar mode. Curve 37 shows the shape of the motor torque.

FIG. 8 shows the shape of the currents 38a, 38b, 38c for each phase of the motor 8 and the respective phase thereof relative to the back e.m.f. 35a, 35b, 35c of said motor 8 phases. This control mode is called 180° unipolar mode. Curve 39 represents the form of the motor torque 8.

A description in FIG. 10 provides guidelines for selecting the best setting of the probes 11 with respect to the references, i.e. the b.e.f.m. signals 35a, 35b, 35c generated by the motor 8 phases. Specifically, FIG. 10 shows the phasing of the signals 40a, 40b, 40c of probes Ha, Hb, He with respect to the back e.m.f. 35a, 35b, 35c of the respective coils for a 120° self-switching mode as well as the phasing of the signals 41a, 41b, 41c of probes Ha, Hb, He with respect to the back e.m.f. 35a, 35b, 35c of the respective coils for a 180° self-switching mode.

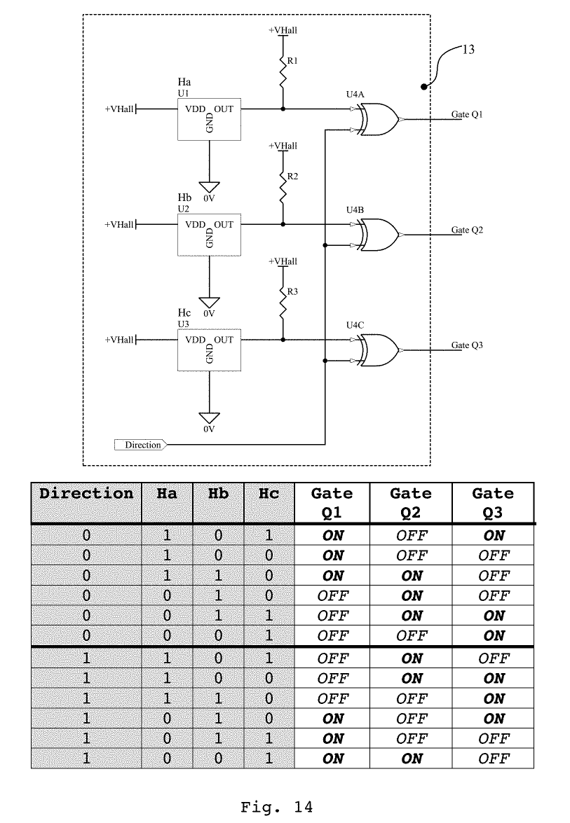

The persons skilled in the art know that the direction 2 of rotation of the motor can be reversed on the one hand by combining the connections of each of the coils of the motor phases, or on the other hand by reversing the signal at the output of each probe 11. This second possibility is the selected solution, implemented by inserting an “EXCLUSIVE OR” function U4a, U4b, U4c at the output of the probes as shown in FIG. 14 to form a bidirectional control 13. A direction signal common to each “EXCLUSIVE OR” gate U4a, U4b, U4c will reverse or not the signal from the probe 11 and will thereby define the direction of rotation of the motor 8. This option 13 is compatible with a bidirectional control in 120° or 180° mode. Another embodiment 13b is shown in FIG. 15 makes it possible to execute the same “EXCLUSIVE OR” function but with discrete components (diodes, resistors and transistors) only, and thus more easily ensures a very good compatibility with high temperature environments. The truth table corresponds to GATE=NOT (DIRECTION+HN). This embodiment may be preferred in applications requiring compatibility with high temperatures >125° C._{ambient}.

The output stage of an ECU 1 controlling an actuator, is typically a mounting (FIG. 23) with four transistors 15a, 15b, 15c, 15d forming a power bridge “H” capable of issuing, at the output 6, a current with a positive or a negative sign defining the direction of rotation of the motor, and having a variable amplitude controlled by hashing the PWM signal applied to the transistors 15a, 15b, 15c, 15d. As the basic electronic circuit 10 does not accept a reverse polarity power supply, using a diode bridge rectifier 27 makes it possible to separate the torque+direction compound signals 6 provided by the ECU 1 as shown in FIG. 4.

The direction+torque compound signal 6 present on the connector 3 supplies the motor 8 after rectification by a diode bridge rectifier 27. The N sensors 11 inform the switching logic 26 of the N power transistors 25 switching the currents in the N phases of the motor 8. The signal 29 taken upstream of the bridge rectifier 27 indicates the direction of rotation to the switching logic 26. A voltage regulator 28 provides the required power to the probes 11 and to the switching logic 26.

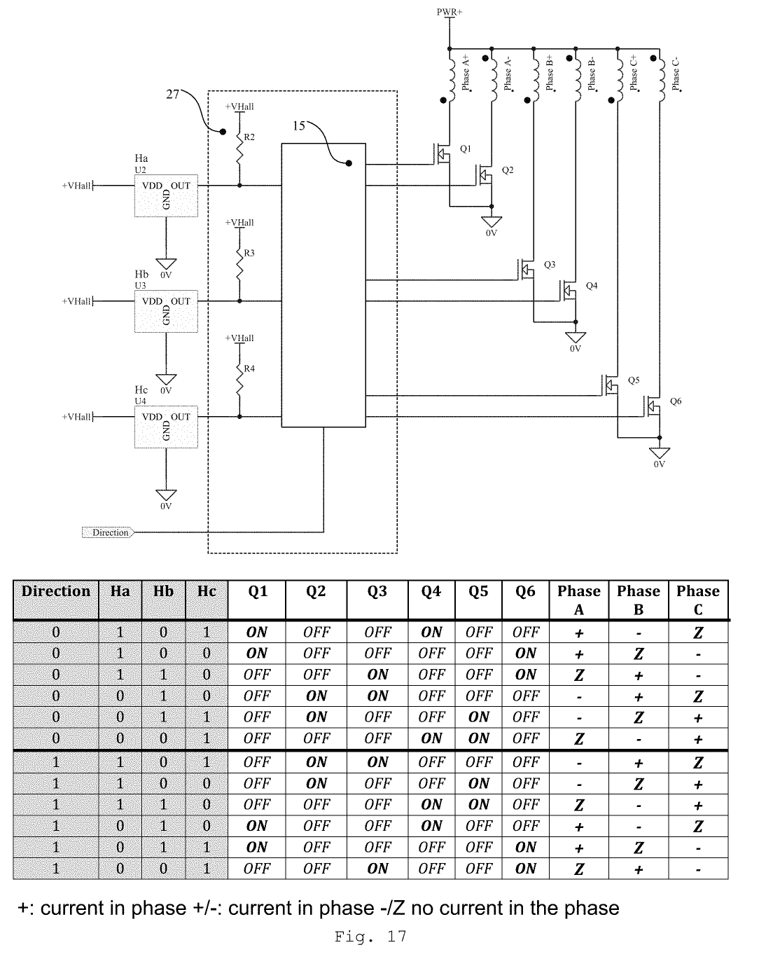

The signal 29 will be taken upstream of the bridge rectifier 27 for the direction signal applied to the “EXCLUSIVE OR” gates U4a, U4b, U4c to be extracted therefrom. As this direction signal is affected by the PWM control generated by the ECU 1 and modulates the current in the motor 8 to control the torque thereof, it is important to format it using a conditioner shown in FIG. 19 and representing an exemplary circuit for extracting the management information contained in the torque+direction control signal 6.

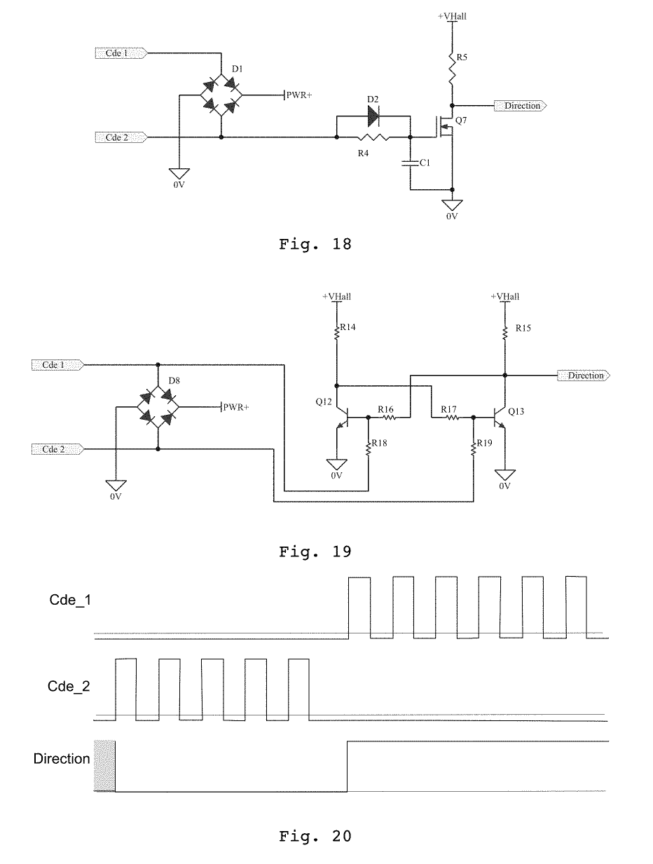

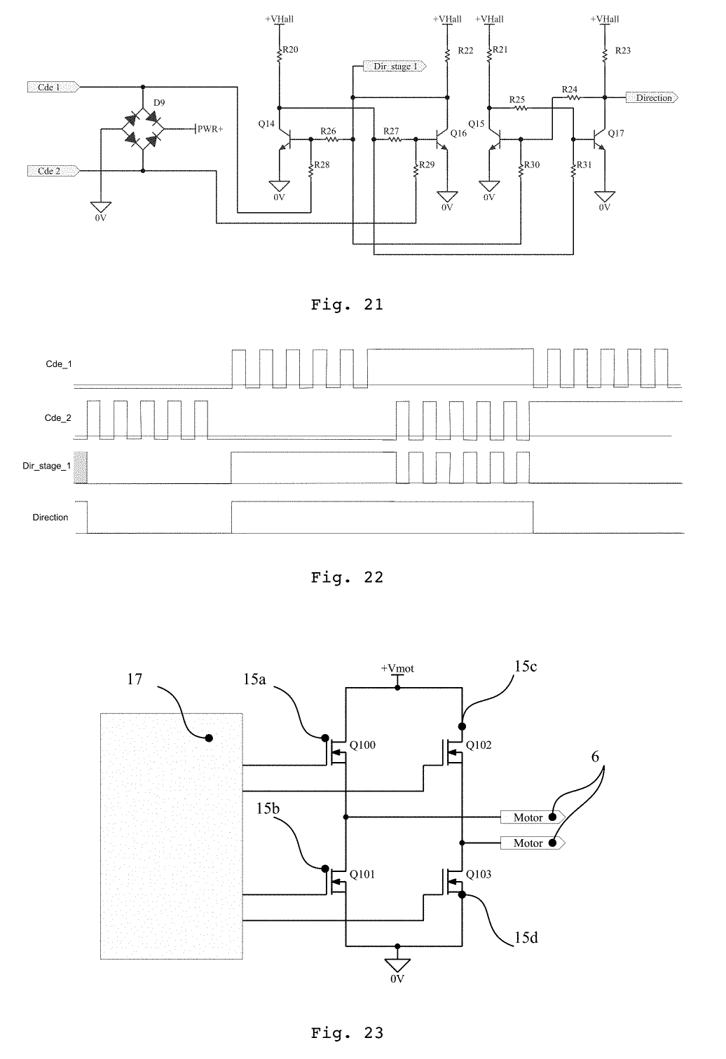

FIG. 19 shows the electronic diagram of a different embodiment having the advantage of automatically adapting to the frequency of the PWM control signal generated by the ECU 1. The torque+direction control signal 6 is applied to the inputs of an RS flip-flop consisting of transistors Q12 and Q13, producing the direction signal as shown in FIG. 20. An extensive electronic circuit using two cascaded RS flip-flops as shown in FIG. 21 makes it possible to extract a direction signal from the bifilar signal 6 regardless of the control mode: hashing on the ‘LOW SIDE’ transistors or hashing on the ‘HIGH SIDE’ transistors (a mode depending on the control algorithm of the ECU 1). The signals produced by such flip-flops are shown in FIG. 22.

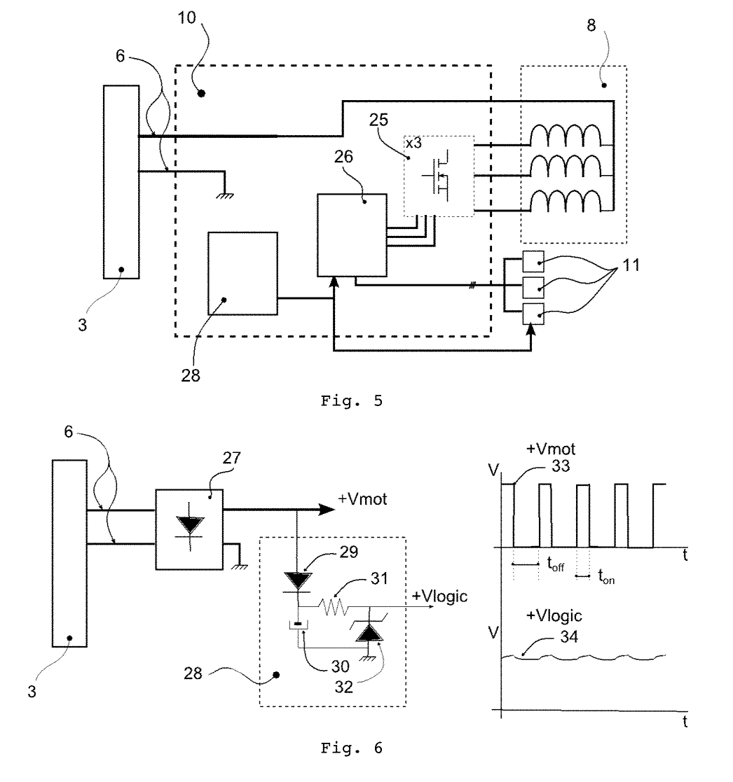

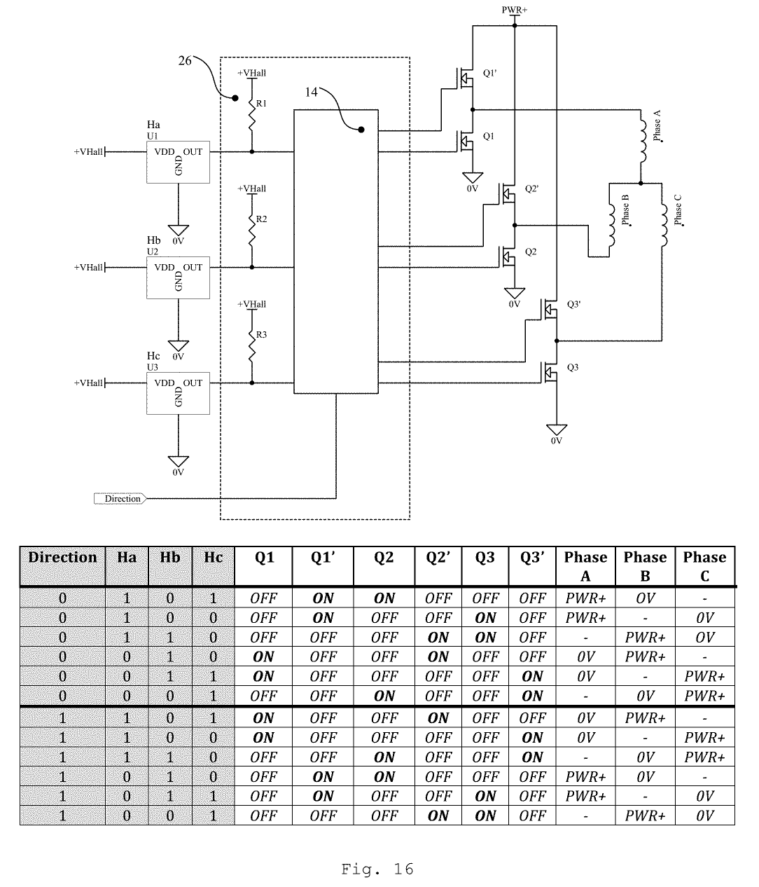

For applications wherein the actuator bidirectional function 2 would not be required, simplifying the electronic diagram and complying with the one proposed in FIG. 5 can be considered. In this case, the signal 6 issued by the ECU 1 contains torque information only. As the polarity of the signal is fixed, the rectifier bridge 27 is no longer essential, and the circuit of extraction of the direction signal (FIG. 18) and “EXCLUSIVE OR” functions U4a, U4b, U4c.

The power signal 6 present on the connector 3 supplies the motor 8. The N sensors 11 inform the switching logic 26 of the N power transistors 25 switching the currents in the N phases of the motor 8. A voltage regulator 28 provides the required power to the probes 11 and to the switching logic 26. In order to maintain compatibility with the existing actuator systems, the source 28 powering the probes 11 and the basic electronic circuit 10 has to be extracted from signals available via the connector 3.

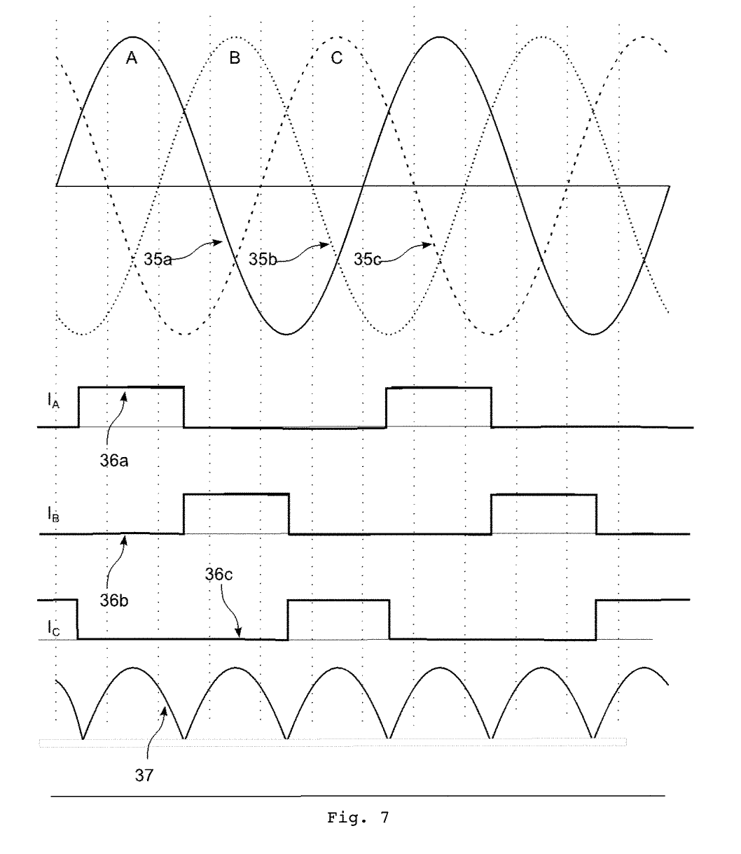

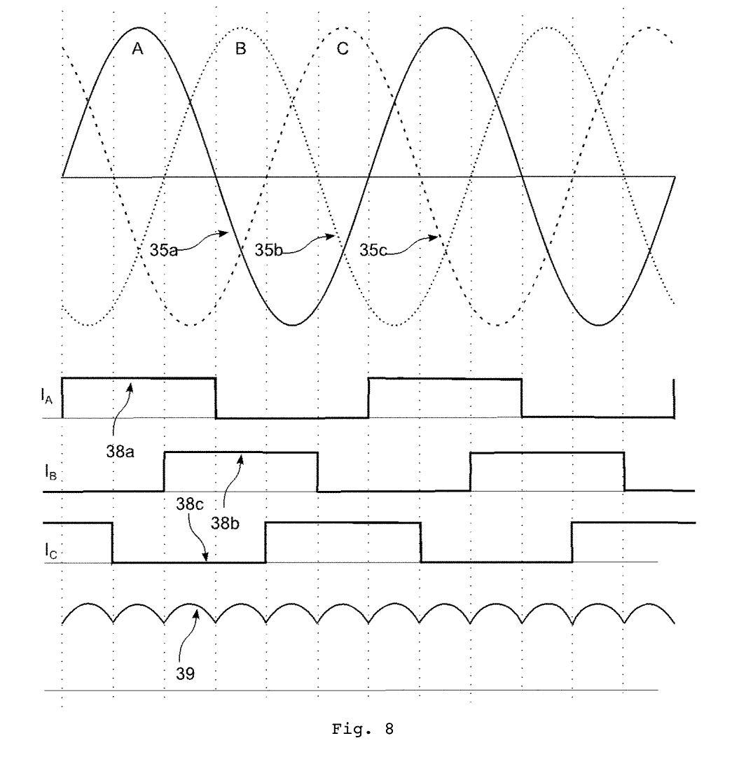

The power source originates from the power signal provided by the ECU, as shown in FIG. 6. The regulator circuit 28 makes it possible to obtain a continuous signal 34 having an adequate amplitude from a hashed signal 33. Here the voltage regulator 28 is powered by the control signal 6. The diode 29/capacitor 30 circuit makes it possible to store the energy transmitted by the PWM control signal 33 during the Tₒₙ time. The resistance 31/zener diode 32 circuit limits voltage to an acceptable value through the components of the self-switching electronics 26. However, the ECU 1 must provide a minimum power signal so that the capacitor 30 can be recharged during the Tₒₙ time. The diode 29 prevents the capacitor 30 from recharging during the motor phases 8. As the components used in this solution are still very basic, these can be selected from a catalogue providing operating temperatures above 125° C.

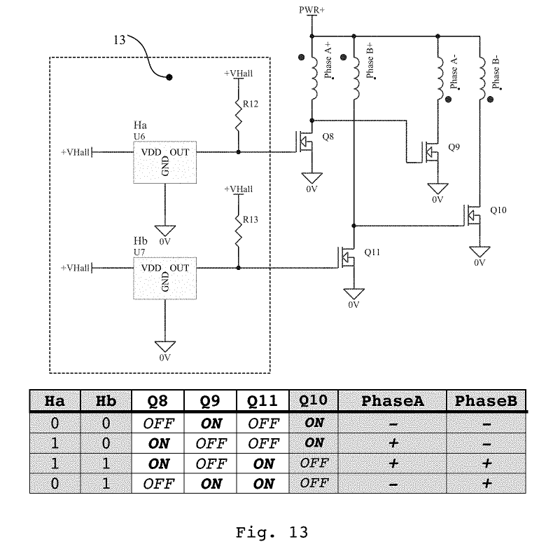

The invention presented above on the basis of an exemplary three-phase motor can as well be applied to a polyphase motor with 1 to N coils. A particular embodiment is shown in FIG. 13, which implements a two-phase brushless DC motor with four half-coils (N=2). Two probes Ha and Hb directly control the state of N A and B phases through four power switches Q8, Q9, Q10 and QII. The detection unit 13 can also integrate the “EXCLUSIVE OR” function, as shown in FIG. 14 and FIG. 15 for the applications requiring a bidirectional control of the brushless DC motor.

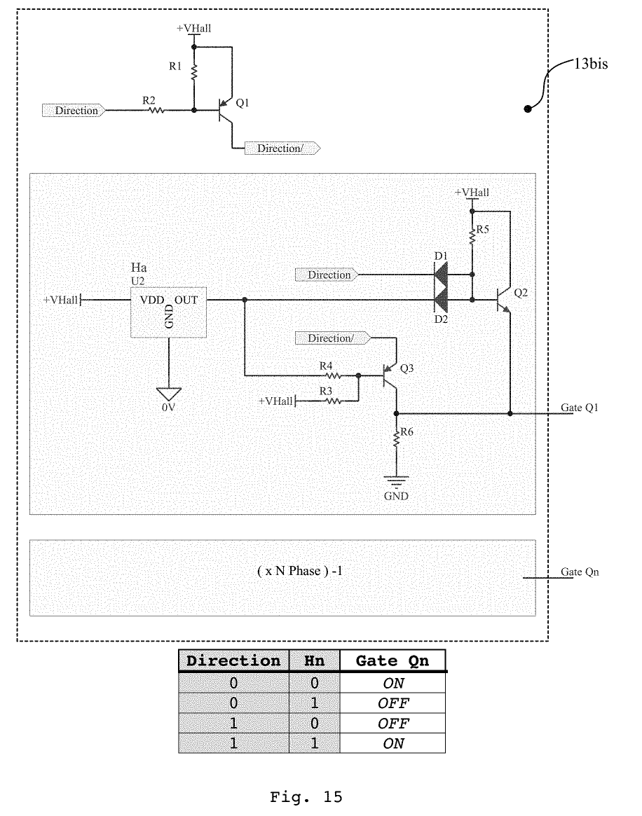

The persons skilled in the art know that the switching of a power switch in series with an inductive load such as the coil of a phase of a motor, generates an overvoltage according to the formula: E=−Ld(i)/d(t). In the conventional diagrams, with three-phase motors (e.g.: FIG. 11 and FIG. 12), the V 191005 (Drain-to-Source Breakdown Voltage) characteristic of the MOSFET transistor is frequently used during the coil degaussing phases. The transistor must then be sized accordingly. In the particular embodiment implementing a “mid-point two-phase” brushless DC motor (FIG. 13), it is advantageous to promote a so-called “two-wire” winding to take advantage of a very good coupling between the half-coils of each phase. Thus obtaining a large mutual inductance A+ Phase/A− Phase and B+ Phase/B− Phase, the magnetic flux will switch from the “A+ Phase” coil to the “A− Phase” coil upon opening the power switch Q8 (Q9 being controlled complementarily). From such coupling, the overvoltage at the terminals of the power switches will be limited to twice the supply voltage PWR+. This also applies to the other motor phase B+ Phase/B− Phase, Q10, QII. The invention disclosed above on the basis of self-switching electronics 26 operating a unipolar control (the current flows in only one direction in the winding) of the brushless DC motor 8, remains applicable to a particular embodiment offering a bipolar control (the current flows in both directions in the coil). FIG. 16 shows the schematic diagram of this particular embodiment; the control logic 14 of the six power transistors Q, Q′, Q2, Q2′, Q3, Q3′ complies with the truth table shown in the same figure.

Such embodiment will be reserved for applications requiring higher efficiency and/or smaller overall motor size. As a counterpart, the basic electronic circuit 10 will consist of six power transistors (three more), and the associated control logic 14 will be more complex than the basic diagrams in FIG. 11 and FIG. 12. Another exemplary particular embodiment provides the same advantages, with a compromise on the optimization of the motor, and is shown in FIG. 17 with its truth table. The difference lies in the use of half-coils.

1. A mechatronic assembly for driving a member comprising a control unit and an actuator, with the control unit comprising a control algorithm and a power bridge, with the algorithm controlling the power bridge, with the power bridge outputting a bifilar electric signal including a torque signal and a direction signal, with the actuator comprising a polyphase brushless electric motor having N phases, binary probes operably detecting a position of a rotor of the motor, power switches suitable for supplying the N phases of the motor from the bifilar electric signal, and a state of the power switches being directly controlled by a signal emitted by the detection probes.

2. A mechatronic assembly for driving the member according to claim 1, wherein the N-phase polyphase motor includes N unipolar or bipolar coils, or N*2 unipolar half-coils.

3. A mechatronic assembly for driving the member according to claim 1, wherein a direction of rotation of the motor imparted by an elementary combinational logic built from the polarity of the bifilar electric signal and the detecting probes signal.

4. A mechatronic assembly for driving the member according to claim 1, wherein the binary probes for detecting the position of the rotor are fed by the bifilar electric signal.

5. A mechatronic assembly for driving the member according to claim 1, wherein the bifilar electric signal is a continuous signal, the amplitude and sign of which are controlled by the control algorithm contained in the control unit.

6. A mechatronic assembly for driving the member according to claim 1, wherein the bifilar electric signal is a hashed signal, the duty cycle of which is controlled by the control algorithm contained in the control unit.

7. A mechatronic assembly for driving the member according to claim 1, wherein the bifilar electric signal is rectified by a diode bridge so as to feed the N phases of the motor with a positive current.

8. A mechatronic assembly for driving the member according to claim 3, wherein the direction of rotation of the motor is determined by a direction signal extracted from the bifilar signal using one or two flip-flops making it independent of the frequency and hashing duty ratio of the bifilar signal.

9. A mechatronic assembly for driving the member according to claim 1, wherein the motor is made of strong magnetic coupling half-coils limiting the dissipation in the power switches during the phases of demagnetization of said coil.

10. A fluid-driving pump comprising a mechatronic assembly comprising a control unit comprising a control algorithm and a power bridge, with an algorithm controlling the power bridge, with the power bridge outputting a bifilar electric signal including a torque signal and a direction signal, with the actuator comprising a polyphase brushless electric motor having N phases, binary probes operably detecting the position of the rotor of the motor, power switches suitable for supplying the N phases of the motor from the bifilar electric signal, and a state of the power switches being directly controlled by a signal emitted by the detection probes.

11. A car camshaft phase-shifter comprising a mechatronic assembly operably driving a member comprising a control unit comprising a control algorithm and a power bridge, with the algorithm controlling the power bridge, with the power bridge outputting a bifilar electric signal including a torque signal and a direction signal, with the actuator comprising a polyphase brushless electric motor having N phases, binary probes operably detecting the position of the rotor of the motor, power switches suitable for supplying the N phases of the motor from the bifilar electric signal wherein a state of the power switches is directly controlled by a signal emitted by the detection probes.
